(19) United States
(12) Patent Application Publication
(10) Pub. No.: US 2026/0196461 A1
(43) Pub. Date: Jul. 9, 2026

(54) BANDPASS MASS FILTER

(71) Applicant: Micromass UK Limited, Wilmslow (GB)

(72) Inventors: David Gordon, Middlewich (GB); David J. Langridge, Macclesfield (GB)

(73) Assignee: Micromass UK Limited, Wilmslow (GB)

(21) Appl. No.: 19/128,254

(22) PCT Filed: Nov. 7, 2023
(86) PCT No.: PCT/GB2023/052896

§ 371 Date: May 8, 2025

(30) Foreign Application Priority Data
Nov. 8, 2022 (GB) 2216612.8

(51) Int. Cl. H01J 49/42; G01N 27/622

(52) U.S. Cl. CPC H01J 49/4215; G01N 27/622

(57) ABSTRACT

A bandpass mass filter comprising: a multipole ion guide; a first RF voltage supply configured to apply a first RF voltage to electrodes of the multipole ion guide for generating an electric field for radially confining ions within the multipole ion guide; and a second RF voltage supply configured to apply a second, different RF voltage to electrodes of the bandpass mass filter, wherein a first phase of the second RF voltage is applied to a first pair of opposing electrodes and a second, different phase of the second RF voltage is applied to a second pair of opposing electrodes; wherein the frequency of the second RF voltage is at least 20 times lower than the frequency of the first RF voltage; and wherein the bandpass mass filter is configured to be maintained at a pressure of ≥10⁻⁴ mbar.

### CROSS-REFERENCE TO RELATED APPLICATION

This application claims priority from and the benefit of United Kingdom patent application No. 2216612.8 filed on 8 Nov. 2022, the entire contents of which are incorporated herein by reference.

### FIELD OF THE INVENTION

The present invention relates generally to mass and/or mobility spectrometers and in particular to a device, for use in such a spectrometer, that operates as a bandpass mass filter.

### BACKGROUND

Resolving quadrupole mass filters are well known devices in which RF and DC voltages are applied to the electrodes so as to select the mass to charge ratios that are capable of being transmitted by the mass filter.

It is also known to apply opposite phases of an auxiliary RF voltage to opposing electrodes in an RF-only ion guide in order to form a dipole that resonantly ejects ions having an undesired mass to charge ratio.

### SUMMARY

From a first aspect the present invention provides a bandpass mass filter comprising: a multipole ion guide; a first RF voltage supply configured to apply a first RF voltage to electrodes of the multipole ion guide for generating an electric field for radially confining ions within the multipole ion guide; a second RF voltage supply configured to apply a second, different RF voltage to electrodes of the bandpass mass filter, wherein a first phase of the second RF voltage is applied to a first pair of opposing electrodes and a second, different phase of the second RF voltage is applied to a second pair of opposing electrodes.

The first RF voltage is also referred to herein as the main RF voltage and the second RF voltage is also referred to herein as the auxiliary RF voltage.

It has been recognised that applying the first phase of the second (auxiliary) RF voltage to one pair of opposing electrodes and applying the second phase of the second RF voltage to another pair of opposing electrodes modifies the stability diagram of an RF ion guide such that it operates as a bandpass filter. This is in contrast to known techniques that apply opposite phases of an auxiliary RF voltage to opposing electrodes, which thereby generates a dipole voltage that resonantly excites and ejects ions. The inventors have recognised that the use of such dipole voltages, particularly at relatively high pressures, can be problematic. For example, such techniques can require large voltage amplitudes to perform mass filtering. Also, dipole voltages are more difficult to apply to the ion guide, both from a mechanical and electrical perspective, than the embodiments described herein. Furthermore, a broadband dipole voltage would be required in order to operate the ion guide as a bandpass mass filter, which is difficult to implement.

The inventors have also recognised that applying only a single phase of an auxiliary voltage to the electrodes will not generate a high mass cut-off for the ion guide. Rather, such techniques would also require a DC voltage to be applied in order to form a band-pass mass filter.

For the avoidance of doubt, electrodes that are described herein as being opposing electrodes are electrodes arranged opposite each other relative to a central, longitudinal axis through the bandpass mass filter (i.e. the axis to which the ions are radially confined).

The first RF voltage alone is capable of generating an electric field within the multipole ion guide that radially confines ions having mass to charge ratios above a threshold value, i.e. above a low mass cut-off value.

The second RF voltage may be configured such that when it is applied to the electrodes of the bandpass mass filter, the electric field within the multipole ion guide only radially confines ions having mass to charge ratios below a threshold value.

The threshold value is a high mass cut-off value. When the first and second voltages are applied to the bandpass mass filter, the electric field within the multipole ion guide also only radially confines ions having mass to charge ratios above a threshold value, i.e. above a low mass cut-off value.

The multipole ion guide may be a multipole rod set ion guide.

The multipole ion guide may be a quadrupole ion guide, such as a quadrupole rod set ion guide.

The second RF voltage supply may be configured to apply the second RF voltage to electrodes of the multipole ion guide.

The first RF voltage supply may be configured to apply a first phase of the first RF voltage to a first pair of opposing electrodes of the multipole ion guide and a second, different phase of the first RF voltage to a second pair of opposing electrodes of the multipole ion guide; and the second RF voltage supply may be configured to apply the first phase of the second RF voltage to the same pair of opposing electrodes to which the first phase of the first RF voltage is applied, and to apply the second phase of the second RF voltage to the same pair of opposing electrodes to which the second phase of the first RF voltage is applied.

The first RF voltage supply may be configured to apply a first phase of the first RF voltage to a first pair of opposing electrodes of the multipole ion guide and a second, different phase of the first RF voltage to a second pair of opposing electrodes of the multipole ion guide; and the second RF voltage supply may be configured to apply the first phase of the second RF voltage to a third pair of opposing electrodes in the bandpass mass filter and to apply the second phase of the second RF voltage to a fourth pair of opposing electrodes in the bandpass mass filter.

For the avoidance of doubt, all of the electrodes in the first, second, third and fourth pairs of electrodes are different electrodes (i.e. eight electrodes are required).

In such embodiments, each electrode to which the second voltage is applied may be arranged circumferentially between, and adjacent to, a multipole electrode to which a first phase of the first RF voltage is applied and a multipole electrode to which a second phase of the first RF voltage is applied.

All of the electrodes in the first and second pairs of electrodes, and optionally also the third and fourth pairs of electrodes, may have the same cross-sectional shape (at any given point along the bandpass filter) and/or cross-sectional area (at any given point along the bandpass filter) and/or length. For example, the bandpass mass filter may have eight (or more) elongated electrodes, such as rod electrodes, to which the first and second voltages are applied.

Alternatively, the electrodes of the third and fourth pairs of electrodes may have a different cross-sectional shape (at any given point along the bandpass filter) and/or cross-sectional area (at any given point along the bandpass filter) and/or length to the electrodes of the first and second pairs of electrodes. For example, the electrodes of the third and fourth pairs of electrodes may be plate or vane shaped electrodes. These plate or vane shaped electrodes may be substantially planar, with their planar surfaces arranged in the radial direction relative to the central, longitudinal axis through the bandpass mass filter. In contrast, the electrodes of the first and second pairs of electrodes may be rod shaped (including axial segmented rods), or may be plate shaped electrodes having their planar surfaces arranged in the axial direction relative to the central axis.

The first and second phases of the first RF voltage may be opposite phases of the first RF voltage and/or the first and second phases of the second RF voltage may be opposite phases of the second RF voltage.

Alternatively, the first and second phases of the first RF voltage may be out of phase by an amount other than 180 degrees and/or the first and second phases of the second RF voltage may be out of phase by an amount other than 180 degrees. For example, the multipole may be a higher order multipole than a quadrupole and different phases on an n-phase first RF voltage supply may be applied to different pairs of opposing electrodes, where n>2. Similarly, different phases on an m-phase second RF voltage supply may be applied to different pairs of opposing electrodes in the bandpass mass filter, where m>2.

The frequency of the second RF voltage may be lower than the frequency of the first RF voltage.

The frequency of the second RF voltage may be at least 20 times lower (or at least 30 times lower, at least 40 times lower, or at least 50 times lower) than the frequency of the first RF voltage.

In other words, the second RF voltage may have a frequency that is ≤5% of the frequency of the first RF voltage. This can help avoid relatively large areas of stability appearing at low values of the q parameter on the Mathieu stability diagram, which would otherwise prevent the ion guide from having an absolute high mass cut-off.

The amplitude of the second RF voltage may be lower than the amplitude of the first RF voltage.

The amplitude of the second RF voltage may be between 1 and 20% of the amplitude of the first RF voltage.

It has been found that such amplitudes provide a sufficiently narrow stability region to operate a practical bandpass filter, whereas higher amplitudes place more requirements on the voltage supplies and can result in the stability region becoming more discontinuous. The amplitude of the second RF voltage may be ≥5% and/or ≤10%. For example, a preferred range for the amplitude of the second RF voltage is between 5 and 10% of the amplitude of the first RF voltage.

The second RF voltage supply maybe configured to vary the amplitude of the second RF voltage with time for changing the range of mass to charge ratios that the bandpass mass filter is capable of transmitting.

For example, increasing the amplitude of the second RF voltage decreases the range of mass to charge ratios which can be transmitted by the bandpass mass filter, for given values of the first and second RF voltages.

The use of a second RF voltage having a frequency that is ≤5% of the frequency of the first RF voltage, and an amplitude that is between 5 and 10% of the amplitude of the first RF voltage has been found to be particularly beneficial in creating a bandpass mass filter with a high mass cut-off.

The bandpass mass filter may be configured to be maintained at a pressure selected from: ≥10⁻⁴ mbar; ≥5×10⁻⁴ mbar; ≥10⁻³ mbar; ≥5×10⁻³ mbar; ≥10⁻² mbar; ≥5×10⁻² mbar; ≥10⁻¹ mbar; ≥1 mbar; ≥100 mbar; or ≥1000 mbar.

The bandpass mass filter may be arranged in a vacuum chamber of a mass spectrometer in order to be maintained at said pressure.

Conventional DC resolving quadrupole mass filters are built with precisely aligned quadrupole electrodes and are operated at pressures of less than 10⁻⁴ mbar in order to provide the desired level of ion transmission and mass resolution. The inventors of the present invention have recognised that a multipole RF ion guide, e.g. having less precisely aligned electrodes, can be adapted by applying an auxiliary RF voltage to its electrodes so that it operates as a bandpass mass filter having an acceptable level of ion transmission and mass resolution, even at relatively high pressures.

The bandpass mass filter may comprise one or more DC voltage supply configured to apply one or more DC voltage to at least one electrode of the bandpass mass filter so as to generate a DC potential gradient along a longitudinal axis of the bandpass mass filter for urging ions along the bandpass mass filter.

The multipole ion guide to which the first RF voltage is applied may be an RF-only ion guide.

The multipole ion guide may be an RF ion guide to which no resolving DC voltage is applied, although one or more DC voltages for providing an axial DC field that drives ions through the ion guide may be applied. In other words, the bandpass mass filter is configured such that the mass to charge ratios that are transmitted are defined by the first and second RF voltages and not by a DC voltage. Preferably, a DC potential difference is not applied between radially opposing, or circumferentially adjacent, electrodes of the multipole ion guide.

The present invention also provides a mass and/or ion mobility spectrometer comprising the bandpass mass filter described herein, wherein the bandpass mass filter is located upstream of a mass analyser and/or ion mobility separator, and wherein the bandpass mass filter is configured to restrict the range of mass to charge ratios that is capable of being transmitted to the mass analyser and/or ion mobility separator.

The mass analyser may be a resolving quadrupole mass filter and/or the ion mobility separator may be a drift time mobility separator that is configured to drive ions along its longitudinal axis and through a background gas in order to separate the ions by mobility.

The bandpass mass filter may be located in a first vacuum chamber and the mass analyser may be located in a second vacuum chamber that is at a lower pressure than the first vacuum chamber.

For example, the spectrometer may be configured to maintain the first vacuum chamber at a pressure that is ≥5×10⁻³ mbar; and/or to maintain the second vacuum chamber at a pressure that is ≤10⁻³ mbar. The second vacuum chamber may be at a pressure that is ≤5×10⁻⁴ mbar or ≤10⁻⁴ mbar.

The mass analyser may be a resolving quadrupole mass filter.

Alternatively, or additionally, the bandpass mass filter may be arranged upstream of a differential pumping aperture between two chambers that are maintained at different pressures. The bandpass mass filter may be configured to restrict the range of mass to charge ratios that is capable of being transmitted to the differential pumping aperture. This may be useful to prevent high mass to charge ratio ions striking the differential pumping aperture and causing contamination and charging of that aperture.

The present invention also provides a method of mass filtering ions comprising: providing a bandpass mass filter as described herein; using the first RF voltage supply to apply the first RF voltage to electrodes of the multipole ion guide; using the second RF voltage supply to apply the second RF voltage to electrodes of the bandpass mass filter, wherein the first phase of the second RF voltage is applied to the first pair of opposing electrodes and the second, different phase of the second RF voltage is applied to the second pair of opposing electrodes; and transmitting ions into the bandpass mass filter.

The present invention also provides a method of mass and/or ion mobility spectrometry comprising a method of mass filtering ions as described herein.

The method may comprise providing a mass and/or ion mobility spectrometer having a mass analyser and/or ion mobility separator, and operating the bandpass mass filter so as to restrict the range of mass to charge ratios that is capable of being transmitted to the mass analyser and/or ion mobility separator.

The mass analyser may be a resolving quadrupole mass filter; and/or the ion mobility separator may be a drift time mobility separator that drives ions along its longitudinal axis and through a background gas in order to separate the ions by mobility.

### BRIEF DESCRIPTION OF THE DRAWINGS

Various embodiments of the present invention will now be described, by way of example only, and with reference to the accompanying drawings in which:

FIG. 1 shows a Mathieu stability diagram for a quadrupole rod set ion guide;

FIG. 2 shows a cross-sectional view through a quadrupole rod set ion guide according to an embodiment of the present invention;

FIGS. 3A-3C show simulations that model the effect on the stability diagram of FIG. 1 when an auxiliary RF voltage having various different amplitudes is also applied to the quadrupole rod set;

FIGS. 4A-4C show simulations that model the effect on the stability diagram of FIG. 3C when the frequency of the auxiliary RF voltages is varied;

FIG. 5 shows two mass spectra that illustrate the differences in data obtained when using a conventional RF-only ion guide and an RF-only ion guide as disclosed herein; and

FIG. 6. shows an arrangement in which a bandpass mass filter according to an embodiment of the present invention is provided as a sacrificial mass filter that is arranged upstream of an analytical quadrupole mass filter.

### DETAILED DESCRIPTION

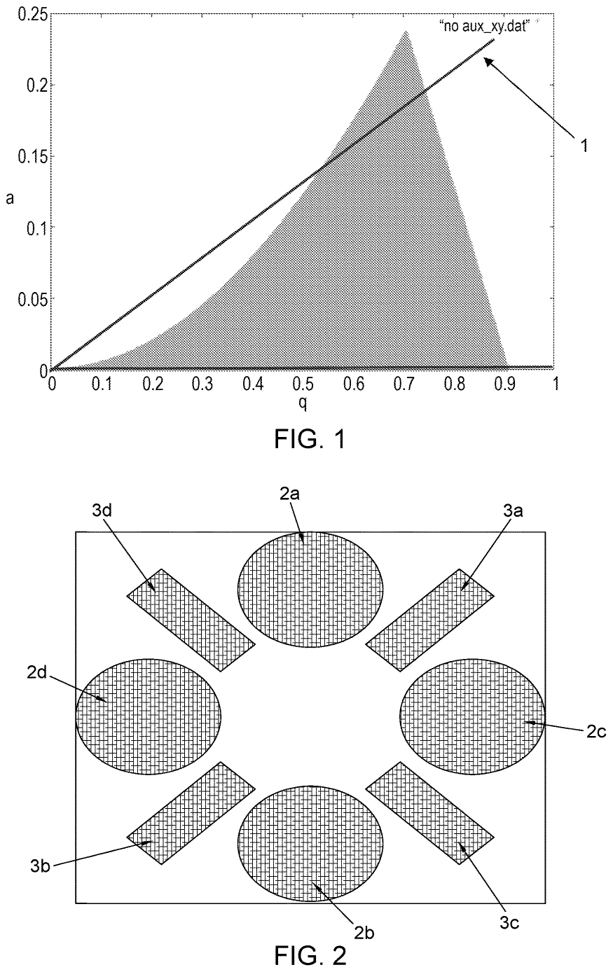

FIG. 1 shows a Mathieu stability diagram for a quadrupole rod set ion guide, where the y-axis represents the parameter a, and the x-axis represents the parameter q. As is well known in the art, the region under the curve is representative of values of RF and DC voltages that may be applied to the quadrupole electrodes such that ions have stable trajectories through the ion guide, whereas the region above the curve represents RF and DC voltages that produce ion trajectories in the ion guide that are unstable.

In a resolving quadrupole rod set mass filter the magnitudes of the RF and DC voltages that are applied to the quadrupole electrodes are scanned or stepped with time during an experimental run such that different mass to charge ratios are transmitted by the mass filter at different, respective times during the experimental run. The voltages are typically scanned or stepped such that the ratio of the magnitudes of the RF and DC voltages remain constant, e.g. so as to follow a linear scan line in the Mathieu stability diagram, such as scan line 1 shown in FIG. 1.

Typically, it is desired for the RF and DC voltages to be applied to the quadrupole electrodes of the mass filter so that the scan line 1 passes through the stable region at a location close to the tip of the stable region. This causes only a narrow range of mass to charge ratios to be able to be transmitted by the mass filter at any given time (i.e. at any given combination of RF and DC voltages) and therefore increases the mass resolution of the mass filter. Ions having mass to charge ratios above this narrow range correspond to the area on the left of the curve in the stability region such that the mass filter has a high mass cut-off, whereas ions having mass to charge ratios below the narrow range correspond to the area on the right of the curve in the stability region such that the mass filter has a low mass cut-off. When the RF and DC voltages are varied with time, the values of mass to charge ratios that fall within the stable region also vary, thus causing different mass to charge ratios to be transmitted by the mass filter at different respective times.

In contrast, only a single RF voltage is applied to the electrodes of a conventional RF-only quadrupole ion guide and a resolving DC voltage is not applied. As such, the value of the parameter a, in the Mathieu stability diagram, is zero. As can be seen from FIG. 1, the RF-only ion guide will theoretically transmit ions from very low values of the parameter q through to a value of q=0.9. The value of q=0.9 therefore represents the low mass cut-off and it is relatively sharp. The lower limit of the parameter q at which ions are stable and transmitted may be as high as 0.2 for low masses, but it may be much less than 0.1 for higher masses. As such, the RF-only ion guide lacks a definitive high mass cut-off and so, for a given RF voltage, there is a relatively wide range of mass to charge ratios that are able to be transmitted by the ion guide. It is therefore not possible for a conventional RF-only quadrupole ion guide to be operated as a narrow bandpass mass filter without adding a resolving DC.

The inventors have recognised that an auxiliary RF voltage can be applied to the RF-only ion guide in a particular manner, in addition to the main RF voltage that is conventionally used for radially confining the ions, so as to cause the ion-guide to operate as a bandpass mass filter.

FIG. 2 shows a cross-sectional view through a quadrupole ion guide 2a-3d according to an embodiment of the present invention. As with a conventional RF-only quadrupole ion guide, two opposing rod electrodes 2a,2b are electrically connected to each other so as to form a first pair of electrodes that will have the same voltage signals applied to them in use. The remaining two opposing rod electrodes 2c,2d are electrically connected to each other so as to form a second pair of electrodes that will have the same voltage signals applied to them in use. A first phase of a main RF voltage is applied to both electrodes 2a,2b in one of the pairs of electrodes and a second, opposite phase of the main RF voltage is applied to both electrodes 2c,2d in the other pair of electrodes, for radially confining ions within the ion guide. Auxiliary electrodes 3a-3d may optionally be provided between circumferentially adjacent quadrupole electrodes 2a-2d, as will be described further below.

As described above, an auxiliary RF voltage may also be applied to the rod electrodes 2a-2d so as to cause the ion guide to operate as a bandpass filter. A first phase of the auxiliary RF voltage may be applied to both of the electrodes 2a,2b in the first pair of electrodes and a second, opposite phase of the auxiliary RF voltage may be applied to both of the electrodes 2c,2d in the second pair of electrodes.

If the auxiliary electrodes 3a-3d are provided, then DC voltages may be applied to the auxiliary electrodes so as to generate an axial DC field along the longitudinal axis of the ion guide, e.g. to urge ions downstream through the ion guide. This may be achieved by providing auxiliary electrodes spaced along the longitudinal axis of the ion guide, and simultaneously applying different DC voltages to the different ones of the auxiliary electrodes so as to generate the axial DC field. Alternatively, one or more DC voltage may be successively applied to successive auxiliary electrodes that are spaced apart in the axial direction such that one or more respective DC potential travels along the axial direction, thereby urging ions in the axial direction. The one or more DC potential may be repeatedly travelled along the device in the axial direction. Alternatively, one or more of the auxiliary electrodes may extend along at least part of the length of the ion guide and may have a resistive coating such that, when a DC voltage is applied to it, a DC potential gradient is generated along the longitudinal axis of the ion guide. Alternatively, one or more of the auxiliary electrodes may extend along at least part of the length of the ion guide and the distance between the auxiliary electrode and the longitudinal axis of the ion guide may vary as a function of distance along the longitudinal axis, such that when a DC voltage is applied to the auxiliary electrode a DC potential gradient is generated along the longitudinal axis of the ion guide.

It is contemplated that the auxiliary RF voltage need not necessarily be applied to the quadrupole rod electrodes 2a-2d, but may be applied to other electrodes. For example, in embodiments that include the auxiliary electrodes 3a-3d, the main RF voltage may be applied to the quadrupole rod electrodes 2a-2d in the manner described above, but the auxiliary RF voltage may be applied to the auxiliary electrodes 3a-3d. In such embodiments, two opposing auxiliary electrodes 3a,3b are electrically connected to each other so as to form a first pair of auxiliary electrodes that will have the same voltage signal applied to them in use, and the remaining two opposing auxiliary electrodes 3c,3d are electrically connected to each other so as to form a second pair of auxiliary electrodes that will have the same voltage signal applied to them in use. A first phase of an auxiliary RF voltage may be applied to both of the electrodes 3a,3b in one of the pairs of auxiliary electrodes and a second, opposite phase of the auxiliary RF voltage may be applied to both of the electrodes 3c,3d in the other pair of auxiliary electrodes. For instance, referring to FIG. 2, the positive phase of the main RF voltage may be applied to the electrodes 2a,2b in the first pair of quadrupole rod electrodes and the positive phase of the auxiliary RF voltage may be applied to the electrodes in the first pair of auxiliary electrodes 3a,3b, whereas the negative phase of the main RF voltage may be applied to the electrodes in the second pair of quadrupole rod electrodes 2c,2d and the negative phase of the auxiliary RF voltage may be applied to the electrodes in the second pair of auxiliary electrodes 2c,3d. In the embodiments where the auxiliary RF voltage is applied to the auxiliary electrodes 3a-3d, one or more DC voltage may or may not be applied to the auxiliary electrodes so as to generate a DC potential gradient along the longitudinal axis of the ion guide in the manner described above.

For the avoidance of doubt, electrodes that are described herein as being opposing electrodes are electrodes arranged opposite each other relative to the central, longitudinal axis through the ion guide (into the page in FIG. 2).

Accordingly, the embodiments of the present invention apply a first phase of the auxiliary RF voltage to one pair of opposing electrodes and a second phase of the auxiliary RF voltage to another pair of opposing electrodes. This modifies the stability diagram for the ion guide such that it operates as a bandpass filter. This is in contrast to applying opposite phases of the auxiliary RF voltage to the electrodes in each pair of opposing electrodes, which would generate a dipole voltage for resonant excitation of the ions. The inventors have recognised that the use of such dipole voltages, particularly at relatively high pressures, can be problematic and can require large voltage amplitudes to perform mass filtering. Also, such dipole voltages are more difficult to apply to the ion guide, both from a mechanical and electrical perspective, than the embodiments described above. Furthermore, a broadband dipole voltage would be required in order to operate the ion guide as a bandpass mass filter, which is difficult to implement. The inventors have also recognised that applying only a single phase of an auxiliary voltage to the electrodes will not generate a high mass cut-off for the ion guide. Rather, such techniques would also require a DC voltage to be applied in order to form a band-pass mass filter.

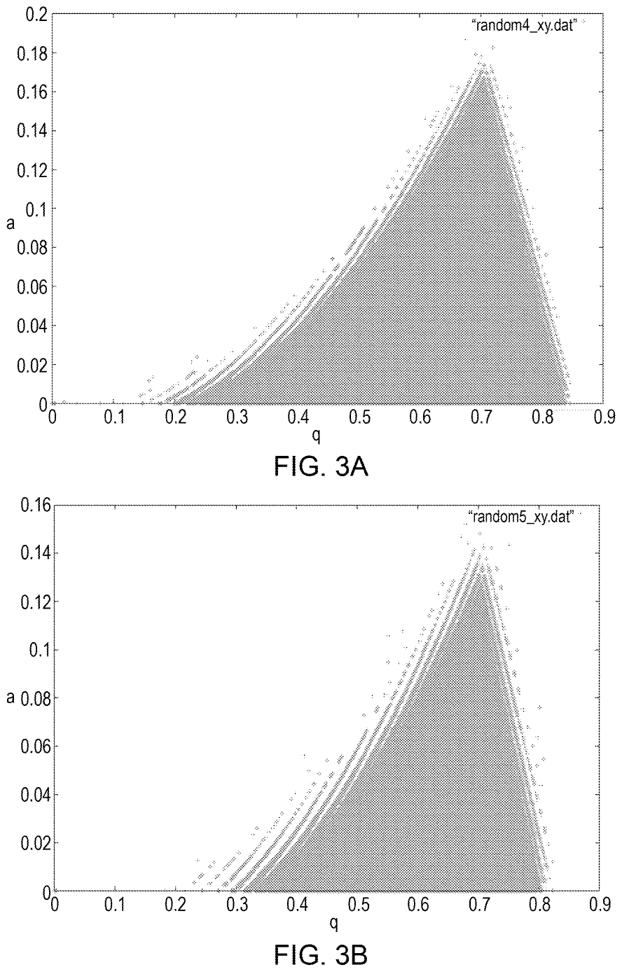

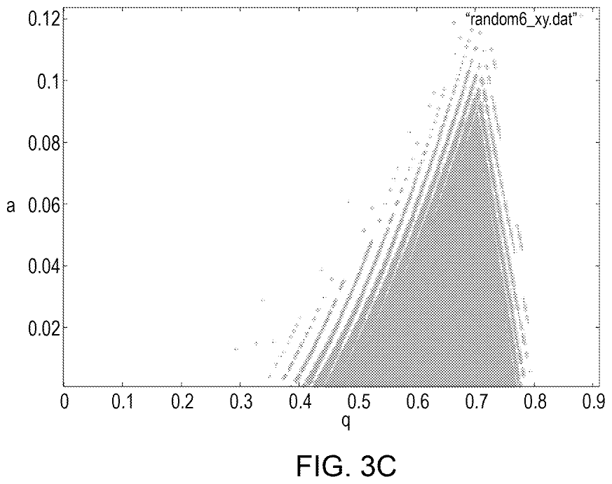

FIGS. 3A-3C show simulations that model the effect on the stability diagram of FIG. 1 when an auxiliary RF voltage having a frequency of 1/50th of the main RF voltage and different amplitudes are also applied to the quadrupole rod set. In accordance with the embodiment described above, a first phase of the auxiliary RF voltage was modelled as being applied to both electrodes in one pair of opposing electrodes in the quadrupole ion guide, and a second phase of the auxiliary RF voltage was modelled as being applied to both electrodes in another pair of opposing electrodes of the ion guide. FIG. 3A shows the stability diagram when the auxiliary RF voltage has an amplitude that is 0.05 times that of the main RF voltage. FIG. 3B shows the stability diagram when the auxiliary RF voltage has an amplitude that is 0.075 times that of the main RF voltage. FIG. 3C shows the stability diagram when the auxiliary RF voltage has an amplitude that is 0.1 times that of the main RF voltage. By way of example, the main RF voltage may have a frequency of 1 MHz and an amplitude of 100 V peak to peak.

As can be seen from FIGS. 3A-3C, varying the amplitude of the auxiliary RF voltage relative to the amplitude of the main RF voltage significantly affects the low q region of the stability diagram, but has relatively little effect on the high q region of the stability diagram. This demonstrates that an auxiliary RF voltage may be applied to the RF-only ion guide in the manner described herein order to alter the range of mass to charge ratios that are able to be transmitted, for a given main RF voltage, and effectively provide a high mass cut-off. This effective high mass cut-off, when combined with the low mass cut-off already present due to the main RF voltage, provides a bandpass mass filter. It can be seen that increasing the amplitude of the auxiliary RF voltage narrows the width of the stability region, which effectively lowers the high mass cut off value, for a given main RF voltage. The amplitude of the auxiliary RF voltage may be selected so as to define the range of mass to charge ratios that is transmitted by the device.

Accordingly, embodiments of the invention may use an auxiliary RF voltage having a relatively low amplitude compared to the main RF voltage. For example, the auxiliary RF voltage may have an amplitude that is 1/10th or less than the amplitude of the main RF voltage. It has been found that such amplitudes provide a sufficiently narrow stability region to operate a practical bandpass filter, whereas higher amplitudes place more requirements on the voltage supplies and can result in the stability region becoming more discontinuous. However, higher amplitudes are contemplated, such as the auxiliary RF voltage having an amplitude that is up to 20% of the amplitude of the main RF voltage.

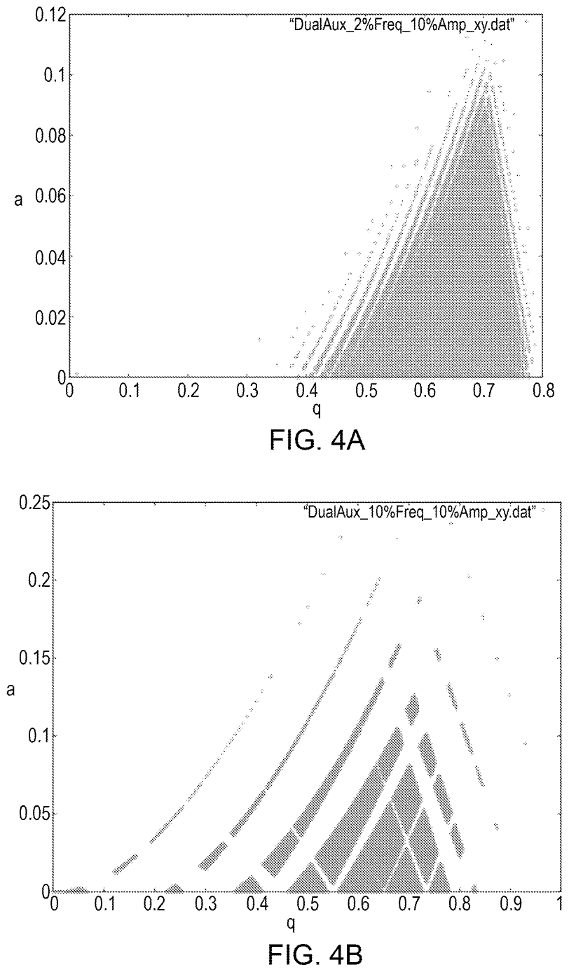

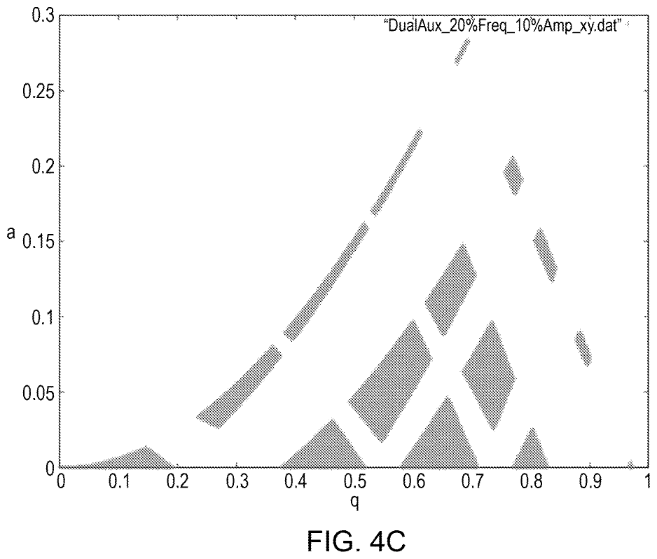

FIGS. 4A-4C show simulations that model the effect on the stability diagram of FIG. 3C when the frequency of the auxiliary RF voltages is varied. Accordingly, in FIGS. 4A-4C the amplitude of the auxiliary RF voltage is 1/10th of the amplitude of the main RF voltage. FIG. 4A shows the stability diagram when the auxiliary RF voltage has a frequency that is 1/50th of the frequency of the main RF voltage. FIG. 4B shows the stability diagram when the auxiliary RF voltage has a frequency that is 1/10th of the frequency of the main RF voltage. FIG. 4C shows the stability diagram when the auxiliary RF voltage has a frequency that is ⅕th of the frequency of the main RF voltage.

It can be seen from the stability diagrams that as the frequency of the auxiliary RF voltage is varied relative to the frequency of the main RF voltage, the areas of stability and the spacings between them vary. For an RF-only ion guide, i.e. where the parameter a is zero, it can be seen that as the frequency of the auxiliary voltage is varied so as to be closer to the frequency of the main RF voltage, the stability diagram splits into more distinct stability islands. More specifically, relatively large areas of stability appear at low values of the q parameter. Although the ion guide will operate as a bandpass mass filter in these areas, the area of stability at low values of the q parameter prevents the ion guide from having an absolute high mass cut-off. Also, large regions of instability begin to appear between the areas of instability, which restrict the size of the mass range over which the mass filter can be operated as a band pass mass filter. Although the amplitude of the auxiliary RF voltage may be increased in order to reduce the size of the higher q stability areas, the low q stability areas are maintained.

It will be appreciated by the skilled person that even when the auxiliary RF voltage has a frequency that is a relatively small fraction of the frequency of the main RF voltage, such as in FIG. 4A, there will still be small islands of instability over very small ranges of mass to charge ratio (e.g. ranges of 0.3 Da). In a conventional low pressure DC resolving mass filter this would be problematic, as ions having mass to charge ratios in these small ranges would be filtered out and so the mass filter would not operate well as a bandpass mass filter. However, as embodiments of the present invention operate the bandpass mass filter at a relatively high pressure, such as ≥10⁻⁴ mbar, the ions collide with background gas molecules more often and so ions having mass to charge ratios in these very small regions of mass instability are still transmitted through the mass filter.

Accordingly, embodiments of the invention may use auxiliary RF voltages having relatively low frequencies relative to the frequency of the main RF voltage. For example, the auxiliary RF voltage may have a frequency that is 1/20th or less than the frequency of the main RF voltage. In other words, the auxiliary RF voltage may have a frequency that is ≤5% of the frequency of the main RF voltage.

It should be noted that each of the stability diagrams shown in FIGS. 3-4 is modelled and therefore shows theoretical areas of stability in the ion guide. In reality the areas of stability are not as discrete as is shown. For example, misalignment of the ion guide electrodes and/or collisions of the ions with background gas molecules can result in some ions that should not be stable in the ion guide being transmitted through the ion guide. As such, the regions of stability in each stability diagram may be more blurred in practice and may not be discrete.

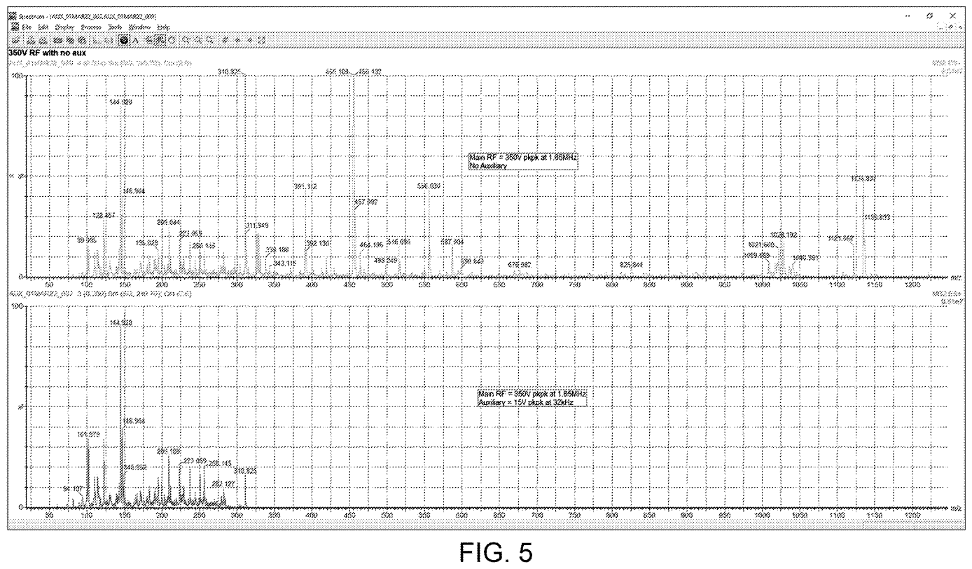

FIG. 5 shows two mass spectra that illustrate the differences in data obtained when using a conventional RF-only ion guide and an RF-only ion guide disclosed herein that is operated as a bandpass mass filter. The upper mass spectrum was obtained when monitoring for a mass of 145 Da and when using a conventional RF-only ion guide that only has a main RF voltage applied to it, where the main RF voltage had an amplitude of 350 V peak-to-peak and a frequency of 1.65 MHz. The lower mass spectrum was obtained under the same conditions as the upper mass spectrum, except that an auxiliary RF voltage was also applied to the ion guide such that it operated as a bandpass mass filter. The auxiliary RF voltage had an amplitude of 15 V peak-to-peak and a frequency of 32 kHz. As can be seen from FIG. 5 the two mass spectra are substantially the same over the lower range of mass to charge ratios, with substantially no loss in signal intensity for the ion of interest (i.e. 145 Da). However, as can be seen, the bandpass mass filter used to obtain the lower mass spectrum has mass filtered out ions above a certain mass to charge ratio.

It will be appreciated that the bandpass mass filter according to the present invention may be used in a variety of applications. For example, the bandpass mass filter may be used as a sacrificial mass filter that is arranged upstream of a resolving mass filter.

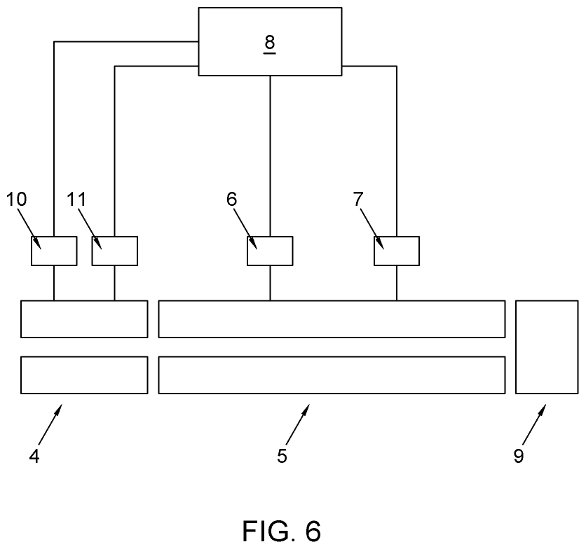

FIG. 6. shows an arrangement in which a bandpass filter 4 according to an embodiment of the present invention is provided as a sacrificial mass filter that is arranged upstream of an analytical quadrupole mass filter 5 being operated as a resolving quadrupole mass filter. As will be appreciated, in the resolving quadrupole mass filter 5 two opposing rod electrodes are electrically connected to each other so as to form a first pair of electrodes, and the remaining two opposing rod electrodes are electrically connected to each other so as to form a second pair of electrodes. An RF voltage supply 6 and a DC voltage 7 supply apply RF and DC voltages, respectively, to the electrodes of the resolving quadrupole mass filter 5 such that the resolving quadrupole mass filter is only capable of transmitting ions having a certain range of mass to charge ratios (i.e. within a mass window) at any given time. A controller 8 is provided so as to control the above described voltage supplies. lons having mass to charge ratios outside of this mass window are filtered out and do not reach the exit end of the resolving quadrupole mass filter 5.

The RF and DC voltages may be varied with time such that the mass to charge ratios capable of being transmitted by the resolving quadrupole mass filter 5 vary with time. For example, the RF and DC voltages may be scanned or stepped with time such that the mass to charge ratios capable of being transmitted by the resolving quadrupole mass filter 5 continuously or discontinuously vary with time.

An ion detector 9 may be provided downstream of the resolving quadrupole mass filter 5 for detecting ions transmitted by the resolving quadrupole mass filter. If an ion is detected by the detector 9, the spectrometer may determine the mass to charge ratio of that ion based on the RF and DC voltages applied to the rod electrodes of the resolving quadrupole mass filter 5 at the time corresponding to the time which the ion was transmitted by the resolving quadrupole mass filter, since the RF and DC voltages determine the mass to charge ratios that are capable of being transmitted.

Additional ion-optical components may be provided between the resolving quadrupole mass filter 5 and the ion detector 9. For example, a fragmentation or reaction device may be provided downstream of the resolving quadrupole mass filter 5 for fragmenting or reacting a precursor ion species that is transmitted by the resolving quadrupole mass filter 5 so as to form fragment or product ions. A further mass filter may be provided between the fragmentation or reaction device and the detector 9 for mass analysing the fragment or product ions. For example, the mass spectrometer may be a tandem quadrupole mass spectrometer.

It will be appreciated that ions that are filtered out by the resolving quadrupole mass filter 5 generally impact on the rod electrodes of that mass filter 5 and are lost. Over time, the inner surfaces of the rod electrodes become contaminated by the ions and electrical charge builds up on these contaminated surfaces. Eventually, local charging of the contaminated surfaces results in degradation of performance of the resolving quadrupole mass filter 5. This may result in loss of ion transmission, loss of mass resolution or poor peak shape of the ion signal from the downstream detector 9. If such contamination occurs then the resolving quadrupole mass filter 5 must be removed from the vacuum chamber and cleaned.

A bandpass mass filter 4 according to the present invention may be used as a sacrificial mass filter arranged upstream of the resolving quadrupole mass filter 5. As described above, a main RF voltage supply 10 applies a main RF voltage to electrodes of the bandpass mass 4 filter for radially confining ions, and an auxiliary RF voltage supply 11 also applies an auxiliary RF voltage to electrodes of the bandpass mass filter 4 so that the mass filter 4 has both a high mass cut-off and a low mass cut-off. lons having mass to charge ratios above the high mass cut-off, and ions having mass to charge ratios below the low mass cut-off, are unstable in the bandpass mass filter 4 and so are filtered out and not transmitted to the resolving quadrupole mass filter 5. Ions having a first range of mass to charge ratios are thus transmitted by the bandpass mass filter 4 into the resolving quadrupole mass filter 5. In contrast, the RF and DC voltages applied to resolving quadrupole mass filter 5 cause only ions in a second, narrower range of mass to charge ratios (e.g. corresponding to a single ion species) to be radially confined and hence transmitted to the exit of the resolving quadrupole mass filter 5. Ions having mass to charge ratios outside of this second range are filtered out by the resolving quadrupole mass filter 5. Therefore, the bandpass mass filter 4 filters out some ions having mass to charge ratios outside of the second range of mass to charge ratios at a location upstream of the resolving quadrupole mass filter 5. As such, these ions are not required to be filtered out by the resolving quadrupole mass filter 5 and hence do not impact on the electrodes of the resolving quadrupole mass filter 5. This helps avoid contamination and surface charging of the electrodes of the resolving quadrupole mass filter 5, which would degrade its ion transmission properties.

The bandpass mass filter 4 may be provided in a first vacuum chamber and the resolving quadrupole mass filter 5 may be provided in a second vacuum chamber, where the first vacuum chamber is at a higher pressure than the second vacuum chamber.

It has been found that the bandpass mass filters 4 disclosed herein are particularly useful at relatively high pressures, since these devices can perform as well as, or better than, a DC resolving mass filter at such pressures, even if the electrodes are slightly misaligned. As described above, the bandpass mass filter 4 may comprise auxiliary electrodes 3a-3d that provide a DC potential gradient in order to drive ions along the bandpass mass filter 4. Alternatively, the quadrupole ion guide electrodes may be axially segmented and different DC voltages may be applied to different ones of the axial segments in order to provide a DC potential gradient for driving ions along the bandpass mass filter.

It is contemplated that the bandpass mass filter described herein may be used upstream of ion-optical devices other than a resolving quadrupole mass filter. For example, the bandpass mass filter described herein may be used as a mass filter that is arranged upstream of an ion mobility separator (IMS). During a single experimental run different groups of ions may be successively passed into an ion mobility separation region in order to separate the ions within each group according to their mobility through a background gas. However, ions having a relatively low mobility may take a relatively long time to traverse the ion mobility separation region and so low mobility ions from a first group of ions may be inadvertently detected when analysing ions from a second, subsequent one of the groups of ions. These low mobility ions may therefore cause erroneous artefact peaks in the mobility spectra.

The bandpass mass filter described herein may be provided upstream of the IMS device in order to restrict the range of mass to charge ratios that is able to be transmitted to the IMS device. As mass to charge ratio and mobility are related, at relatively high pressures, the bandpass device is able to restrict the range of mobilities that pass into the IMS device so as to prevent ions from any given group of ions being detected whilst analysing ions from a subsequent one of the groups of ions. For example, the bandpass device may restrict the range of mobilities that pass into the IMS device so as to prevent ions from any given group of ions being present in the ion separation region whilst ions from another group of ions are present in the ion separation region.

Although the present invention has been described with reference to various embodiments, it will be understood by those skilled in the art that various changes in form and detail may be made without departing from the scope of the invention as set forth in the accompanying claims.

For example, although embodiments have been described in which the bandpass mass filter is a quadrupole rod set ion guide, it is contemplated that the ion guide may instead comprise higher order multipole rod sets.

The quadrupole, or higher order, multipole rod set electrodes may be axially segmented electrodes or may be continuous electrodes. The electrodes may be rod shaped or other shapes, such as plates.

Although embodiments have been described in which the bandpass mass filter is an RF-only ion guide, i.e. one to which only AC voltages are applied, it is contemplated that a resolving DC voltage may also be applied to the bandpass mass filter in order to improve the maximum achievable mass resolution of the device. This enables the mass resolution to be higher than that which can be provided by the RF-only device or a conventional DC resolving mass filter.

1. A bandpass mass filter comprising:
a multipole ion guide;
a first RF voltage supply configured to apply a first RF voltage to electrodes of the multipole ion guide for generating an electric field for radially confining ions within the multipole ion guide; and
a second RF voltage supply configured to apply a second, different RF voltage to electrodes of the bandpass mass filter, wherein a first phase of the second RF voltage is applied to a first pair of opposing electrodes and a second, different phase of the second RF voltage is applied to a second pair of opposing electrodes;
wherein the frequency of the second RF voltage is at least 20 times lower than the frequency of the first RF voltage; and
wherein the bandpass mass filter is configured to be maintained at a pressure of ≥10⁻⁴ mbar.

2. The bandpass mass filter of claim 1, wherein the second RF voltage is configured such that when it is applied to the electrodes of the bandpass mass filter, the electric field within the multipole ion guide only radially confines ions having mass to charge ratios below a threshold value.

3. The bandpass mass filter of claim 1, wherein the multipole ion guide is a quadrupole ion guide, such as a quadrupole rod set ion guide.

4. The bandpass mass filter of claim 1, wherein the second RF voltage supply is configured to apply the second RF voltage to electrodes of the multipole ion guide.

5. The bandpass mass filter of claim 4, wherein the first RF voltage supply is configured to apply a first phase of the first RF voltage to a first pair of opposing electrodes of the multipole ion guide and a second, different phase of the first RF voltage to a second pair of opposing electrodes of the multipole ion guide; and
wherein the second RF voltage supply is configured to apply the first phase of the second RF voltage to the same pair of opposing electrodes to which the first phase of the first RF voltage is applied, and to apply the second phase of the second RF voltage to the same pair of opposing electrodes to which the second phase of the first RF voltage is applied.

6. The bandpass mass filter of claim 1, wherein the first RF voltage supply is configured to apply a first phase of the first RF voltage to a first pair of opposing electrodes of the multipole ion guide and a second, different phase of the first RF voltage to a second pair of opposing electrodes of the multipole ion guide; and
wherein the second RF voltage supply is configured to apply the first phase of the second RF voltage to a third pair of opposing electrodes in the bandpass mass filter and to apply the second phase of the second RF voltage to a fourth pair of opposing electrodes in the bandpass mass filter.

7. The bandpass mass filter of claim 1, where the first and second phases of the first RF voltage are about 180 degrees out of phase; and where the first and second phases of the second RF voltage are about 180 degrees out of phase.

8. The bandpass mass filter of claim 1, wherein the frequency of the second RF voltage is at least 30 times lower than the frequency of the first RF voltage.

9. The bandpass mass filter of claim 8, wherein the frequency of the second RF voltage is at least 50 times lower than the frequency of the first RF voltage.

10. The bandpass mass filter of claim 1, wherein the amplitude of the second RF voltage is lower than the amplitude of the first RF voltage.

11. The bandpass mass filter of claim 10, wherein the amplitude of the second RF voltage is between 1 and 20% of the amplitude of the first RF voltage.

12. The bandpass mass filter of claim 10 or 11, wherein the second RF voltage supply is configured to vary the amplitude of the second RF voltage with time for changing the range of mass to charge ratios that the bandpass mass filter is capable of transmitting.

13. The bandpass mass filter of claim 1, wherein the bandpass mass filter is configured to be maintained at a pressure of ≥10⁻³ mbar.

14. The bandpass mass filter of any claim 1, comprising one or more DC voltage supply configured to apply one or more DC voltage to at least one electrode of the bandpass mass filter so as to generate a DC potential gradient along a longitudinal axis of the bandpass mass filter for urging ions along the bandpass mass filter.

15. The bandpass mass filter of claim 1, where the multipole ion guide is an RF ion guide to which no resolving DC voltage is applied.

16. A mass and/or ion mobility spectrometer comprising the bandpass mass filter of any claim 1, wherein the bandpass mass filter is located upstream of a mass analyser and/or ion mobility separator, and wherein the bandpass mass filter is configured to restrict the range of mass to charge ratios that is capable of being transmitted to the mass analyser and/or ion mobility separator.

17. The spectrometer of claim 16, where the mass analyser is a resolving quadrupole mass filter; and/or where the ion mobility separator is a drift time mobility separator that is configured to drive ions along its longitudinal axis and through a background gas in order to separate the ions by mobility.

18. The spectrometer of claim 16, wherein the bandpass mass filter is located in a first vacuum chamber and the mass analyser is located in a second vacuum chamber that is at a lower pressure than the first vacuum chamber.

19. A method of mass filtering ions comprising:
providing a bandpass mass filter according to claim 1;
using the first RF voltage supply to apply the first RF voltage to electrodes of the multipole ion guide;
using the second RF voltage supply to apply the second RF voltage to electrodes of the bandpass mass filter, wherein the first phase of the second RF voltage is applied to the first pair of opposing electrodes and the second, different phase of the second RF voltage is applied to the second pair of opposing electrodes; and
transmitting ions into the bandpass mass filter.

20. (canceled)

21. A bandpass mass filter comprising:
a multipole ion guide;
a first RF voltage supply configured to apply a first RF voltage to electrodes of the multipole ion guide for generating an electric field for radially confining ions within the multipole ion guide; and
a second RF voltage supply configured to apply a second, different RF voltage to electrodes of the bandpass mass filter, wherein a first phase of the second RF voltage is applied to a first pair of opposing electrodes and a second, different phase of the second RF voltage is applied to a second pair of opposing electrodes.
